(19) United States
(12) Patent Application Publication
(10) Pub. No.: US 2006/0109974 A1
(43) Pub. Date: May 25, 2006

(54) System and method for IVR transfer of an inbound call

(75) Inventors: Jonathan Paden, Austin, TX (US); Jon Harris, Little Elm, TX (US); Paul L. Dent, Austin, TX (US); Bobby Sams, Austin, TX (US)

Correspondence Address: LARSON NEWMAN ABEL POLANSKY & WHITE, LLPL.L.P., 5914 WEST COURTYARD DRIVE, SUITE 200, AUSTIN, TX, 78746, US

(73) Assignee: SBC Knowledge Ventures, L.P.

(21) Appl. No.: 10/996,127

(22) Filed: Nov. 23, 2004

(51) Int. Cl. H04M 3/00; H04M 5/00; H04M 3/42

(52) U.S. Cl. 379/265.02; 379/212.01

(57) ABSTRACT

In a method and system for transferring an inbound call received by a first agent, input information describing agent authentication and call destination is received from the first agent. The first agent is directed to conference in the inbound call in response to receiving the input information. A first sequence of tone signals is generated in response to the conference. After placing the inbound call on hold, a ‘wait for digits’ signal identifying a carrier servicing the inbound call is detected. A carrier dependent transfer sequence is selected for transferring the inbound call from the first agent to a second agent preferably without the inbound call being hair pinned through the first agent.

### FIELD OF THE DISCLOSURE

The present disclosure relates generally to telecommunication systems, and more particularly to processing calls in telecommunication systems deploying interactive voice response (IVR) systems.

### BACKGROUND

A telecommunication system typically enables communication of data/information, ranging from voice to video, between a sender and a receiver distributed across a communications network including the Internet. Use of a toll free telephone system has become very popular with businesses, especially for providing sales and customer service, thereby allowing prospective as well as existing customers to call the business from anywhere in the country. Callers making telephone calls to these businesses via toll free service numbers, such as 800 numbers and their equivalents, are typically routed by the preferred carrier's telephone network for each business to their customer call center(s).

With increasing inbound call volumes and decreasing number of call handling agents available to handle the inbound calls, businesses have relied on the use of automated telephone routing systems such as IVR systems to meet the demand. As is well known, IVR systems typically process inbound phone calls using voice inputs, play pre-recorded messages including real-time information retrieved from customer databases and/or the Internet, and potentially transfer calls to an available in-house call handling agent for further assistance.

While handling inbound calls, it is a common requirement for an agent in a first call center to redirect an inbound calf to another agent located in a second call center. For example, after being serviced by an agent in a reservation department for an airline, an inbound caller may request a transfer to another agent in the reservation department for a partner auto rental company. Different carriers such as AT&T Corporation and Sprint Corporation may be selected to service the inbound calls. Call transfer sequences, methods or steps may vary based on various factors such as carrier, technology of telephone switch used, and the like. For example, a call transfer sequence supported by one carrier may be initiated by dialing a ‘* 8’ command on a touch tone phone. However, some calls may be received which may not recognize and/or support a ‘*8’ initiated call transfer. As such, many call centers may not be properly equipped and/or trained to properly transfer the inbound calls having unknown call transfer characteristics in an efficient, consistent and error free manner. The result may be an improper transfer of calls, placement of inbound calls on indefinite hold and similar problems. Agent confusion and limitations associated with the telecommunication system and/or the carrier may result in a frustrating experience for the caller. Also, improper call transfer can lead to a cross-connected (also known as hair-pinned) call through the IVR that increases the telecom expense of the call and increases required inbound call capacity.

Accordingly, a need exists to provide an improved method and system for transferring inbound calls.

### BRIEF DESCRIPTION OF THE DRAWINGS

FIG. 1 illustrates a schematic block diagram of a telecommunication system for transferring a call;

FIG. 2 is a schematic block diagram illustrating further details of the system of FIG. 1;

FIG. 3 is a flow chart illustrating a method for transferring an inbound call; and

FIG. 4 illustrates a block diagram of a computer system for implementing the system of FIG. 1.

### DETAILED DESCRIPTION OF THE DRAWINGS

The disclosed system and method provides a stand-alone voice activated IVR program that allows agents to simply dial in and state a desired destination. Once the destination is determined, the IVR will ask the agent to bring the caller on the line and then send the transfer sequence. By having the caller on the line, the first leg of the call hears a first tone and places the caller on hold while listening for an additional tone. Once the IVR plays an additional tone sequence, the first instance connects to the new destination (as if the agent had performed *8 without the outbound call). At this point, the agent may disconnect the TAIVR, or keep the IVR on the line for additional assistance. The agent may then use any of the additional transfer features normally available. Agent commands can be performed directly from keypad or by voice or DTMF command to the TAIVR.

In a particular embodiment, the present disclosure is directed to a system and method for transferring calls independent of the carrier. In the disclosed method and system, a determination of the carrier is made and a corresponding call transfer method is selected to automate the transfer of the inbound call. In a method and system for transferring an inbound call received by a first agent, input information describing agent authentication and call destination is received from the first agent. The first agent is directed to conference in the inbound call in response to receiving the input information. A first sequence of tone signals is generated in response to the conference. After placing the inbound call on hold, a ‘wait for digits’ signal identifying a carrier servicing the inbound call is detected. A carrier dependent transfer sequence is selected for transferring the inbound call from the first agent to a second agent preferably without the inbound call being hair pinned (i.e. cross-connected), through the first agent.

In one embodiment, a transfer assist interactive voice response (TAIVR) system for transferring an inbound call includes a voice component operable to interact with a first agent receiving the inbound call. The voice component receives voice input information from the first agent and generates at least one voice output directing the first agent to conference in the inbound call in response to the voice input information. The system also includes a switching component operable to detect a carrier servicing the inbound call responsive to the conference in of the inbound call. A carrier dependent transfer sequence is selected for transferring the inbound call.

The disclosed system and method provides an automated technique for a true release transfer of inbound calls that is independent of the carrier and/or specific transfer methods. The true release transfer technique enables efficient and cost effective subsequent transfers of the inbound call to other agents since the inbound calls are transferred without being hair pinned through the redirecting agent.

The functionality of various systems, nodes, devices or components described herein may be implemented as hardware (including discrete components, integrated circuits and systems-on-a-chip), firmware (including application specific integrated circuits and programmable chips) and/or software or a combination thereof, depending on the application requirements.

Inbound calls, such as calls made to a toll free 800 number, may be received by a network switch (such as a 4ESS electronic switching system available from AT&T). Each network switch and/or a plurality of switches may have an associated adjunct node for routing an inbound call from a caller located at a customer location to an agent located at a call center. When requested, the adjunct node may also redirect the inbound call from one agent to another. An interactive voice response (IVR) system may be configured to include one or more adjunct nodes to automate the handling of inbound calls.

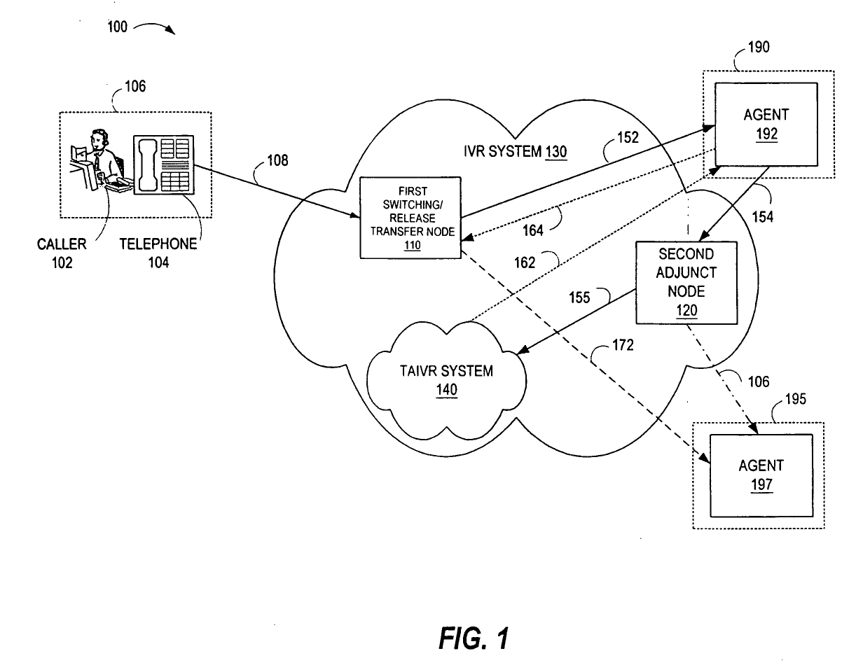

FIG. 1 illustrates a schematic block diagram of a telecommunication system 100 for transferring a call. In the depicted embodiment, the telecommunication system 100 includes a first node 110, such as a switch that can handle a release transfer and a second adjunct node 120 included in an interactive voice response (IVR) system 130 for receiving a plurality of inbound calls and selectively directing at least one call to one of a plurality of agents. The IVR system 130 also includes a transfer assist interactive voice response (TAIVR) system 140 accessible by the plurality of agents to assist in the automated transfer of at least one of the inbound calls. As described herein, the plurality of agents may include human agents and/or IVR systems configured to provide services similar to those provided by the human agents.

In the depicted embodiment, a caller 102 using a telephone 104 located at a customer location 106 places an inbound call into a business by dialing its telephone number, such as a toll free 800 service number. The first node 110, working in conjunction with a network switch (not shown), is operable to receive the inbound call via communication link 108, which is serviced by a carrier, such as AT&T, Sprint, MCI or the like. In one embodiment, the IVR system 130 uses audio input/output to interact with the caller 102 by providing requested information and/or by selectively transferring the inbound call to an agent 192 located at a call center 190 communications via link 152. In one embodiment, the IVR system 130 receives DTMF signals to interact with the caller 102.

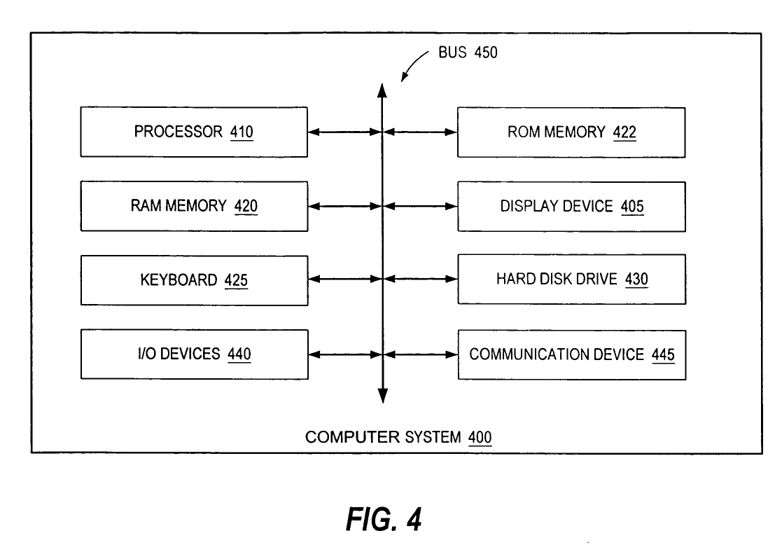

The inbound call placed via the link 108 has an associated, predefined call transfer sequence from an original destination to a redirected destination. The transfer sequence may vary based on factors such as the carrier servicing the inbound calls, the functionality of the telephone switch, the customer selected feature set of the inbound telephone line, and the like. Additional details of an illustrative transfer sequence associated with a call transfer are described in FIG. 4.

In the depicted embodiment, the second adjunct node 120, working in conjunction with a network switch (not shown), is operable to receive a plurality of inbound calls having different transfer sequence characteristics compared to those of the inbound call. The second adjunct node 120 may also selectively disable certain transfer characteristics. That is, the second adjunct node 120 is operable to selectively disable certain different transfer sequence characteristics of the call, such as the ‘*8’ enabled transfer. In one embodiment, the IVR system 130 uses voice input/output to interact with the plurality of inbound calls received by the second adjunct node 120 by providing requested information and/or by selectively transferring the inbound calls in accordance with a predefined transfer sequence.

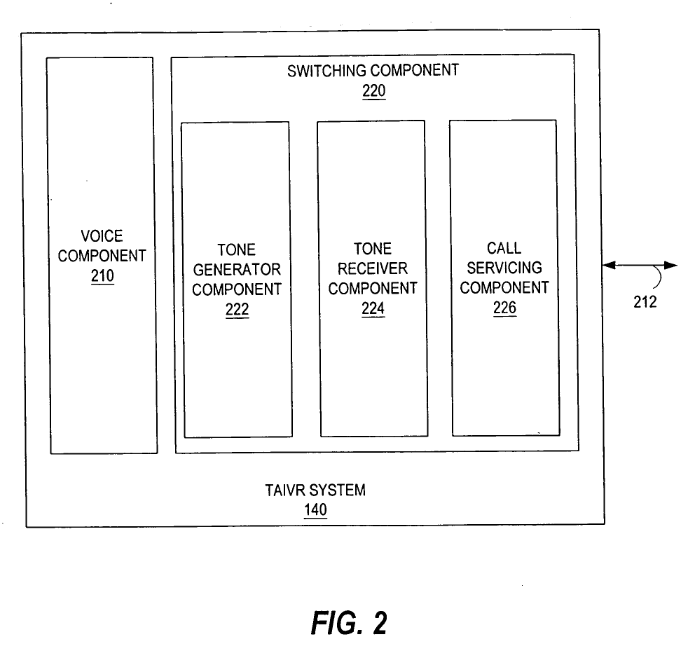

In the depicted embodiment, the transfer assist interactive voice response (TAIVR) system 140 is accessible by any of the plurality of agents for automatically transferring a call. The TAIVR system 140 provides a transfer command that is independent of the carrier and/or a particular transfer sequence associated with the call. In the depicted embodiment, the TAIVR system 140 is included in the IVR system 130. In one embodiment, the TAIVR system 140 may be a standalone system that is separate from the IVR system 130. In one embodiment, the TAIVR system 140 uses voice input/output and/or DTMF signals for interaction with agents. Additional detail of the TAIVR system 140 is described with reference to FIG. 2.

In a particular embodiment, at least one of the plurality of agents accesses the TAIVR system 140 for requesting a call transfer by dialing into one of the plurality of inbound call lines for the TAIVR system 140. A dialed call made from agent 192 to a particular access line to the TAIVR system 140 is serviced by the second adjunct node 120, e.g., via link 154. In one embodiment, the agent 192 and/or the caller 102 may determine that the inbound call needs to be transferred to another destination, such as to an agent 197 located at a second call center 195. The agent 192 dials out to the TAIVR system 140 via links 154 and 155 with the second adjunct node 120 handling inbound calls having a different transfer sequence than the inbound call. In one embodiment, the agent 192 may dial out the particular access number for the TAIVR system 140 where the particular access number is configured to a particular transfer sequence, such as where ‘*8’ enabled transfers are functionality disabled. In one embodiment, the second adjunct node 120 receiving the dial out call to the TAIVR system 140 may be configured to selectively disable the particular ‘*8’ enabled transfer.

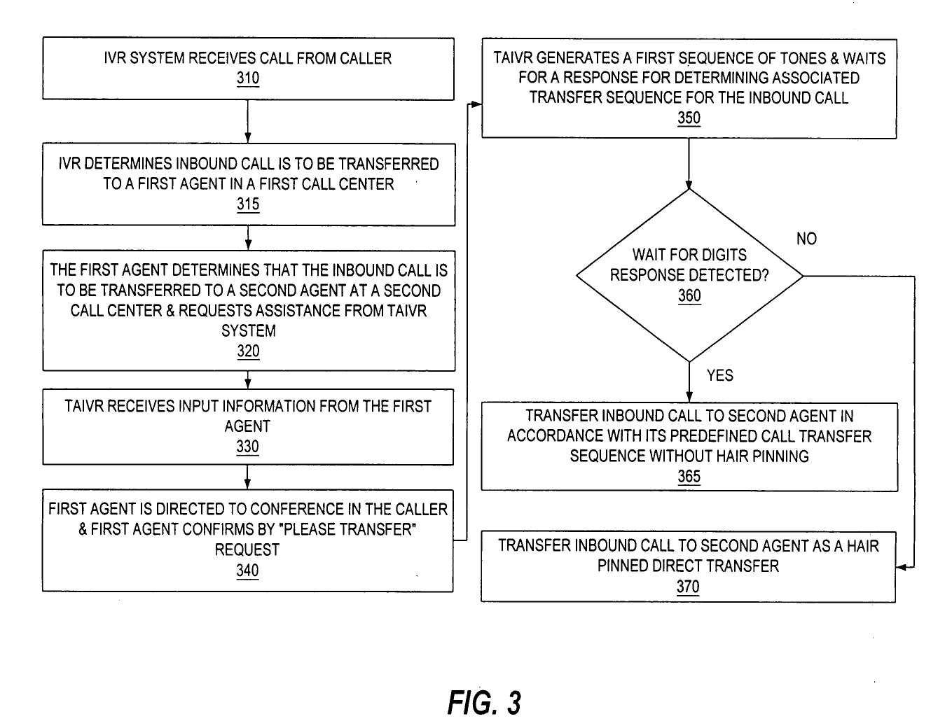

The TAIVR system 140 is operable to: 1) detect a presence of a first carrier (by generating DTMF signals 162 and 164 communicated over existing links), and 2) select a call transfer sequence for transferring the inbound call from the first agent 192 to the second agent 197, via link 172 in a manner that is consistent with the first carrier. Additional details of a technique for transferring a call that is independent of the carrier and/or a particular transfer sequence associated with the call are described with reference to FIG. 3. In one embodiment, any one and/or all of the links 108, 152, 154, 155, 106, and 172 may include a plurality of lines or channels.

FIG. 2 is a schematic block diagram illustrating further details of an illustrative embodiment of the TAIVR system 140 of FIG. 1. In the depicted embodiment, the TAIVR system 140 includes: 1) a voice component 210 operable to interact with a plurality of agents and 2) a switching component 220 operable to determine whether the inbound call supports a particular transfer sequence and to select a transfer sequence in response to the determination. The TAIVR system 140 includes at least one link 212, to communicate with other devices and/or agents.

In the depicted embodiment, the voice component 210 is operable to interact with the agent 192. The interaction may use voice input/output and/or DTMF signals. In one embodiment, the voice component 210 receives input information from the agent 192 in response to the agent 192 dialing out to access the TAIVR system 140. In a particular embodiment, the input information includes authentication information such as an employee identification (ID) number to verify the credentials of the agent 192 making the call transfer request. In one embodiment, the input information also includes call center destination information to make the call transfer.

In a particular embodiment, the switching component 220 is operable to: 1) automatically determine whether the inbound call supports a particular transfer sequence, such as a ‘*8’ enabled transfer function and 2) select the particular transfer sequence, if supported, for transferring the inbound call to another agent without hair pinning through agent 192, i.e. without a cross-connect connection through the IVR 130. In a particular embodiment, the determination of whether the inbound call supports a particular transfer sequence may include detecting a presence of the particular carrier servicing the inbound call.

In a particular embodiment, the switching component 220 includes a tone generator component 222 operable to generate a first sequence of tone signals such as generation of the ‘*8’ command sequence using DTMF signals 162 and 164 and a second sequence of tone signals such as a predefined code number, e.g., ‘312’, uniquely identifying a redirected transfer destination such as “Midwest Consumer Billing”. The first sequence of DTMF signals may include a unique personal identifier for the first agent and the second sequence of tones may correspond to a predefined touchtone sequence unique to the second agent.

In one embodiment, a third sequence of tone signals for uniquely identifying yet another redirected transfer destination is generated. The switching component 220 also includes a tone receiver component 224 operable to receive a ‘wait for digits’ signal identifying the carrier. For example, in response to receiving the first sequence of tone signals, e.g., the ‘*8’ transfer command, and based on the particular carrier servicing the inbound call, the system responds by generating a ‘wait for digits’ signal, such as a dial tone. In one embodiment, a different ‘wait for digits’ signal may be generated when a ‘*8’ is entered (instead of a standard dial tone). Generation of the ‘wait for digits’ signal indicates a confirmation of the availability of the ‘*8’ enabled transfer function for the inbound call. In one embodiment, various types of ‘wait for digits’ signals corresponding to multiple carriers and/or platforms may be predetermined and stored. A match may be made to determine the type of call transfer functionality enabled on the inbound call. The switching component 220 includes a call servicing component 226 operable to service inbound calls. Services provided may include placing the inbound call on hold or conferencing in the inbound call.

In a particular embodiment, the TAIVR system 140 is implemented as a computer system. In this embodiment, the TAIVR system 140 is programmed to make a call transfer in accordance with predefined rules. For example, the TAIVR system 140 includes business logic or a “rules” engine, which disables the agent 192 from attempting a call transfer to a center that is closed. Additionally, if the redirected transfer destination has a high hold time, the TAIVR system 140 detects the high hold time condition and advises the agent 192 prior to the transfer attempt. As an additional example, the TAIVR system 140 monitors call center operating status, such as an outage and automatically advises and disables all transfer calls to the affected call center.

FIG. 3 is a flow chart illustrating a method for transferring an inbound call, according to an illustrative embodiment. At step 310, the caller 102 enters the IVR system 130 via the first adjunct node 110 by dialing the inbound call. At step 315, the IVR system 130 determines that the inbound call is to be transferred to a first agent 192 located at a first call center 190. In one embodiment, a first carrier servicing the inbound call supports the call transfer sequence based on ‘*8’ command functionality. However, the agent 192 who may receive a plurality of incoming calls may not be aware of the particular call transfer sequence characteristics corresponding to each of the incoming calls.

At step 320, the first agent 192 determines that the inbound call is to be transferred to another call center location responsible for a particular function. For example, the first agent 192 may determine that the caller 102 is requesting billing information and needs to be transferred to a billing call center which handles the caller's account, e.g., the “Midwest Consumer Billing”. Instead of looking up confusing codes and/or telephone number information for the “Midwest Consumer Billing”, the agent 192 simply seeks assistance from the TAIVR system 140 to make the automated transfer. The agent 192 places the inbound call on hold, obtains an outside line and dials out the access number for the TAIVR system 140, via the second adjunct node 120 servicing the dialed out calls.

At step 330, the TAIVR system 140 receives input information from the first agent 192. The input information may include agent authentication information and destination information (received after verifying the authenticity of the credentials supplied by the first agent 192). The input information includes a destination for the inbound call. The authenticated information may include a PIN code or call center code. The destination may be provided by a voice command from the agent 192. DTMF or other methods may also be used. Additional interaction can occur between the agent and the TAVIR. For example, the TAVIR may prompt the first agent for caller information such as BTN or User ID, enabling the IVR to reference customer data and advise the agent of any special circumstances pertaining to customers, such as business class, premium customer, known policy violations, chronic/frequent caller, etc. The TAVIR can correct potential misroutes by determining if the destination provided by the agent is not valid for the customer type, and confirming any exception with the agent prior to transfer.

At step 340, in response to receiving the destination information, such as “Midwest Consumer Billing,” the TAIVR system 140 directs the first agent 192 to take the inbound call off hold and conference in the inbound call for a 3-way conference call between the TAIVR system 140, the first agent 192 and the caller 102. The first agent 192 verifies that the inbound call has been conferenced in by providing a voice input, e.g., “Please Transfer,” to the TAIVR system 140.

At step 350, the TAIVR system 140 generates a first sequence of tone signals in response to the 3-way conference. The first sequence is generated for detecting a presence of a carrier servicing the inbound call and for determining an associated transfer sequence for the inbound call. In a particular embodiment, the first sequence is a ‘*8’ command using DTMF signals. The first sequence is detected by the first and second adjunct nodes 110 and 120. However, since calls received by the TAIVR system 140 on a predefined access line are not enabled for ‘*8’ transfer, the first sequence has no effect on the second adjunct node 120, e.g., it does not place the first agent 192 on hold. The first adjunct node 110 detects the first sequence and in response, places the inbound call on hold and generates a ‘wait for digits’ signal.

At step 360, the TAIVR system 140 determines if the carrier, in response to the first sequence, generates the ‘wait for digits’ signal. At step 365, the ‘wait for digits’ signal is detected and the TAIVR system 140 selects an associated transfer sequence corresponding to the inbound call. The associated transfer sequence is generated for transferring the inbound call to the agent 197 without the inbound call being hair pinned through the first agent 192.

At step 370, if no ‘wait for digits’ signal is detected, then the TAIVR system 140 directly transfers the inbound call to the second agent 197 by an associated transfer sequence, e.g., a hair pinned direct transfer. That is, the system 140 transfers the inbound call via the first agent 192 and the second adjunct node 120 to the second agent 197.

Various steps described above may be added, omitted, combined, altered, or performed in a different order. For example, steps 330, 340, 350, 360, 365 and 370 may be repeated for another transfer of inbound calls from the agent 197 to yet another agent.

For purposes of this disclosure, the telecommunication system 100 may include any instrumentality or aggregate of instrumentalities operable to transmit, receive, compute, classify, process, retrieve, originate, switch, store, display, manifest, detect, record, reproduce, handle, or utilize any form of information, intelligence, or data for consumer, business, scientific, control, or other purposes. For example, the telecommunication system 100 may comprise an electronic switch, a computer, or any other suitable computing device and may vary in size, shape, performance, and functionality.

FIG. 4 illustrates a block diagram of a particular embodiment of a computer system 400 for implementing the TAIVR system 140 of FIG. 1. The computer system 400 includes a processor 410, a system random access memory (RAM) 420 (also referred to as main memory), a non-volatile ROM 422 memory, a display device 405, a keyboard 425 and an I/O controller 440 for controlling various input/output devices such as voice input/output generating devices and DTMF signal receiving/generating devices. It should be understood that the term “computer system” is intended to encompass any device having a processor that executes instructions from a memory medium. The computer system 400 is shown to include a hard disk drive 430 connected to the processor 410 although some embodiments may not include the hard disk drive 430. The processor 410 communicates with the system components via a bus 450, that includes data, address and control lines. The computer system 400 may include multiple instances of the bus 450. A communications controller 445, such as a network interface card, may be connected to the bus 450 to enable information exchange between the computer system 400 and other devices.

In a particular embodiment, each of the first and second adjunct nodes 110 and 120 described in FIG. 1 is implemented by the computer system 400. The processor 410 is operable to execute the computing instructions and/or operations of the computer system 400. The memory medium, e.g., RAM 420, preferably stores instructions (also known as a “software program”) for implementing various embodiments of a method in accordance with the present disclosure. In various embodiments the one or more software programs are implemented in various ways, including procedure-based techniques, component-based techniques, and/or object-oriented techniques, among others.

Although illustrative embodiments have been shown and described, a wide range of modification, change and substitution is contemplated in the foregoing disclosure and in some instances, some features of the embodiments may be employed without a corresponding use of other features. For example, while certain aspects of the present disclosure have been described in the context of a telecommunication system, those of ordinary skill in the art will appreciate that the processes disclosed are capable of being distributed in the form of a computer readable medium of instructions in a variety of forms. Examples of computer readable media include RAM, flash memory, recordable-type media such as a floppy disk, a hard disk drive, a ROM, CD-ROM, DVD and transmission-type media such as digital and/or analog communication links, e.g., the Internet. As another example, those of ordinary skill in the art will appreciate that the processes disclosed are capable of being distributed, e.g., the functions provided by the TAIVR system 140 may easily be implemented in one or more adjunct nodes. Those of ordinary skill in the art will appreciate that the system and methods illustrated herein may vary depending on the implementation.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present invention.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of transferring an inbound call, the method comprising:
receiving input information from a first agent that receives the inbound call, wherein the input information identifies a destination for the inbound call;
directing the first agent to conference in the inbound call;
generating a first sequence of tone signals in response to the conference;
placing the inbound call on hold in response to the first sequence;
detecting a ‘wait for digits’ signal, wherein the ‘wait for digits’ signal identifies carrier information associated with the inbound call; and
selecting a transfer sequence for the inbound call in response to the carrier information.

2. In the method of claim 1, wherein the transfer sequence comprises:
generating a second sequence of tone signals responsive to the ‘wait for digits’ signal, wherein the second sequence is indicative of the destination for transferring the inbound call to a second agent without the inbound call being hair pinned through the first agent.

3. In the method of claim 1, wherein the transfer sequence comprises:
transferring the inbound call to a second agent by direct transfer in response to an absence of the ‘wait for digits’ signal, wherein the direct transfer results in the inbound call being hair pinned through the first agent.

4. In the method of claim 2, further comprising:
receiving corresponding input information from the second agent, wherein the input information from the second agent describes another destination for the inbound call.

5. In the method of claim 4, wherein a third sequence of tone signals is generated in response to a ‘wait for digits’ signal, wherein the third sequence is indicative of the another destination for transferring the inbound call to a third agent.

6. The method of claim 2, wherein the second sequence of tone signals are dual tone multifrequency (DTMF) signals corresponding to a predefined touch tone sequence unique to the second agent.

7. In the method of claim 1, wherein the input information includes a unique personal identifier for the first agent.

8. In the method of claim 1, wherein the input information is received as a voice signal.

9. In the method of claim 1, wherein the input information is received as a dual tone multifrequency (DTMF) signal.

10. The method of claim 1, wherein the first sequence of tone signals are dual tone multifrequency (DTMF) signals corresponding to a ‘*8’ touch tone sequence.

11. The method of claim 10, wherein the inbound call supports the ‘*8’ sequence and a dial-out call placed by the first agent to provide the input information does not support the ‘*8’ sequence.

12. A transfer assist interactive voice response (TAIVR) system for transferring an inbound call, the system comprising:
a voice component operable to interact with a first agent receiving the inbound call, wherein the voice component receives input information from the first agent and generates at least one output directing the first agent to conference in the inbound call; and
a switching component operable to detect a carrier servicing the inbound call and to select a transfer sequence for transferring the inbound call in response to the detected carrier.

13. The system of claim 12, wherein the transfer sequence is selected based on a destination for the inbound call, the destination being included in the input information.

14. The system of claim 12, wherein the switching component comprises:
a tone generator component operable to generate a first sequence of tone signals and a second sequence of tone signals;
a tone receiver component operable to receive a ‘wait for digits’ signal identifying the carrier; and
a call servicing component operable to service the inbound call.

15. The system of claim 14, wherein the service includes holding and conferencing in the inbound call, wherein the second sequence is generated in response to the ‘wait for digits,’ wherein the second sequence is indicative of a destination for the inbound call, and wherein the inbound call is transferred to the second agent without the inbound call being hair pinned through the first agent.

16. The system of claim 14, wherein the second sequence transfers the inbound call to a second agent by direct transfer and, wherein the direct transfer results in the inbound call being hair pinned through the first agent.

17. The system of claim 14, wherein the first sequence of tone signals are dual tone multifrequency (DTMF) signals corresponding to a ‘*8’ touch tone sequence.

18. The system of claim 15, wherein the tone generator is operable to generate a third sequence of tone signals for transferring the inbound call from the second agent to a third agent.

19. The system of claim 15, wherein the second sequence of tone signals are dual tone multifrequency (DTMF) signals corresponding to a predefined touch tone sequence that is unique to the second agent.

20. The system of claim 12, wherein the input information includes a unique personal identifier for the first agent.

21. The system of claim 12, wherein the input information is received as a dual tone multifrequency (DTMF) signal.

22. A program product stored on a computer readable medium for controlling transfer of an inbound call, the program product comprising:
a voice program operable to interact with a first agent receiving the inbound call, wherein the voice program receives input information from the first agent and generates at least one output directing the first agent to conference in the inbound call; and
a switching program operable to detect a carrier servicing the inbound call and to select a transfer sequence for transferring the inbound call based on the detected carrier.

23. The program product of claim 20, wherein the computer readable medium includes recordable media.

24. A telecommunication system comprising:
a first and second adjunct node included in an interactive voice response (IVR) system for receiving a plurality of inbound calls, wherein the first adjunct node is operable to receive a first inbound call serviced by a first carrier having a first call transfer sequence, wherein the IVR selectively directs the first inbound call to one of a plurality of agents, wherein the second adjunct node is operable to receive a second inbound call having a second call transfer sequence that is different than the first call transfer sequence; and
a transfer assist interactive voice response (TAIVR) system accessible by the plurality of agents, wherein one of the plurality of agents accesses the TAIVR by placing the second inbound call, wherein the TAIVR is operable to detect an identity of the first carrier and select the first call transfer sequence for transferring the first inbound call from the one of the plurality of agents to a different agent in response to the identity of the first carrier.

25. In the system of claim 24, wherein the first transfer sequence includes the TAIVR selecting a transfer of the first inbound call to the different agent without the first inbound call being hair pinned through the one of the plurality of agents.

26. In the system of claim 24, wherein the TAIVR selects a transfer of the first inbound call to the different agent by direct transfer with the first inbound call being hair pinned through the one of the plurality of agents in response to an absence of the first carrier.
